(19) United States
(12) Patent Application Publication
(10) Pub. No.: US 2017/0186218 A1
(43) Pub. Date: Jun. 29, 2017

(54) METHOD FOR LOADING 360 DEGREE IMAGES, A LOADING MODULE AND MOBILE TERMINAL

(71) Applicants: Le Holding (Beijing) Co., Ltd., Beijing (CN); Le Shi Zhi Xin Electronic Technology (Tianjin) Limited, Binhai New Area (CN)

(72) Inventor: Xiaofei XU, Binhai New Area (CN)

(21) Appl. No.: 15/236,764

(22) Filed: Aug. 15, 2016

Related U.S. Application Data
(63) Continuation of application No. PCT/CN2016/089567, filed on Jul. 10, 2016.

(30) Foreign Application Priority Data
Dec. 28, 2015 (CN) 2015110228165

(51) Int. Cl. G06T 15/20; G06T 5/00; H04N 5/232; G06T 15/04

(52) U.S. Cl. CPC G06T 15/20; G06T 15/04; G06T 5/006; H04N 5/23238

(57) ABSTRACT

Embodiments of the present disclosure relate to the field of image display technologies, and disclose a 360-degree image loading method and electronic device. In some embodiments of the present disclosures, the 360-degree image loading method includes the following steps: generating, by a first data layer, a three-dimensional image; acquiring, by the first data layer, a current viewpoint; rendering, by the first data layer, the three-dimensional image in a current viewing angle range to a texture according to the current viewpoint, to generate a texture image; transmitting, by the first data layer, a texture reference sign of the texture image to a second data layer; and acquiring, by the second data layer, the texture image according to the texture reference sign, and performing anti-distortion processing on the texture image. According to the 360-degree image loading method and loading module, and the mobile terminal provided in some embodiments of this application, in a 360-degree video display process, transmission of a large amount of video broadcast control data between the first data layer and the second data layer is avoided, improving the program development efficiency.

### CROSS-REFERENCE TO RELATED APPLICATIONS

The present application is a continuation of PCT application No. PCT/CN2016/089567 submitted on Jul. 10, 2016. The present disclosure claims priority to Chinese Patent Application No. 201511022816.5, filed with the Chinese Patent Office on Dec. 28, 2015 and entitled “360-DEGREE IMAGE LOADING METHOD AND LOADING MODULE, AND MOBILE TERMINAL”, which is incorporated herein by reference in its entirety.

### TECHNICAL FIELD

This application relates to the field of image display technologies, and in particular, to a 360-degree image loading method and an electronic device.

### BACKGROUND

360-degree panorama is a technology that on the basis of a static image, the virtual reality (VR) can be implemented on a microcomputer platform. On the basis of the 360-degree panorama, a person can perform 360-degree panoramic observation on a computer and implement, by means of an interactive operation, free browsing, thereby experiencing a three-dimensional VR visual world.

The inventor finds during implementation of this application that in an android mobile phone-based VR solution, implementation of a 360-degree panoramic viewing manner is usually that rendering engine is implemented on a native layer on the basis of C++. That is, an android java layer transmits an original two-dimensional image to a native layer, and after the native layer renders and draws the original two-dimensional image, the native layer transmits the original two-dimensional image to the java layer for displaying. In this process, a large amount of video broadcast control data of the JNI (Java Native Interface) standard needs to be transmitted between the android java layer and the native layer; and it is inconvenient to debug code of the JNI standard. Therefore, a current design pattern causes great inconvenience to developers.

### SUMMARY

This present disclosure provides a 360-degree image loading method and electronic device, so that in a 360-degree video display process, transmission of a large amount of video broadcast control data between two data layers is avoided, improving the program development efficiency.

According to a first aspect, an embodiment of this present disclosure provides a 360-degree image loading method, including the following steps: generating, by a first data layer, a three-dimensional image; acquiring, by the first data layer, a current viewpoint; rendering, by the first data layer, the three-dimensional image in a current viewing angle range to a texture according to the current viewpoint, to generate a texture image; transmitting, by the first data layer, a texture reference sign of the texture image to a second data layer; and acquiring, by the second data layer, the texture image according to the texture reference sign, and performing anti-distortion processing on the texture image.

According to a second aspect, an embodiment of this present disclosure provides a non-volatile computer storage medium, including a computer executable instruction, where when the computer executable instruction is executed by at least one processor, the computer executable instruction causes the processor to execute the foregoing method.

According to a third aspect, an embodiment of this present disclosure further provides an electronic device, including: at least one processor; and a memory for storing instructions executable by the at least one processor, where execution of the instructions by the at least one processor causes the at least one processor to execute any foregoing 360-degree image loading method of this application.

According to the 360-degree image loading method and electronic device provided in the embodiments of this present disclosure, embodiment, in a 360-degree video display process, the first data layer generates a three-dimensional image, and transmits a texture reference sign of a texture image only in a current viewing angle range to a second data layer; and the second data layer acquires the texture image according to texture reference sign, and performs anti-distortion processing on the texture image. That is, in a 360-degree video display process, only the texture reference sign needs to be transmitted between the first data layer and the second data layer, so that transmission of a large amount of video broadcast control data between the first data layer and the second data layer is avoided, improving the program development efficiency. Moreover, rendering and drawing of the three-dimensional image is complemented in the first data layer, that is, data related to the rendering and drawing needs to be used only in the first data layer but not used in the second data layer, thereby effectively avoiding sharing of data related to the rendering and drawing between the first data layer and the second data layer, and simplifying complexity of program development.

In an embodiment, the first data layer is a java layer, and the second data layer is a native layer, that is, the present disclosure can be implemented on the basis of an android platform.

### BRIEF DESCRIPTION OF THE DRAWINGS

One or more embodiments are exemplarily described by using figures that are corresponding thereto in the accompanying drawings; the exemplary descriptions do not form a limitation to the embodiments. Elements with same reference signs in the accompanying drawings are similar elements. Unless otherwise particularly stated, the figures in the accompanying drawings do not form a scale limitation.

FIG. 1 is a flowchart of a 360-degree image loading method according to Embodiment 1 of the present disclosure;

FIG. 2 is a flowchart of a 360-degree image loading module according to Embodiment 2 of the present disclosure; and

FIG. 3 is a schematic structural diagram of hardware of an electronic device according to Embodiment 4 of the present disclosure.

### DETAILED DESCRIPTION

To make objectives, technical solutions, and advantages of this application clearer, the following clearly and completely describes, with reference to the figures in embodiments of this application, the technical solutions of this application by means of embodiments. Obviously, the embodiments described are some embodiment, not all embodiment of the present disclosure.

Embodiment 1 of the present disclosure relates to a 360-degree image loading method and is applied to an electronic device such as a mobile terminal. The mobile terminal may be an android platform-based smartphone, and therefore, a first data layer and a second data layer in this embodiment respectively are a java layer and a native layer. However, a development platform for the smartphone is not limited in this embodiment, and when the development platform are different, the first data layer and the second data layer are also different accordingly.

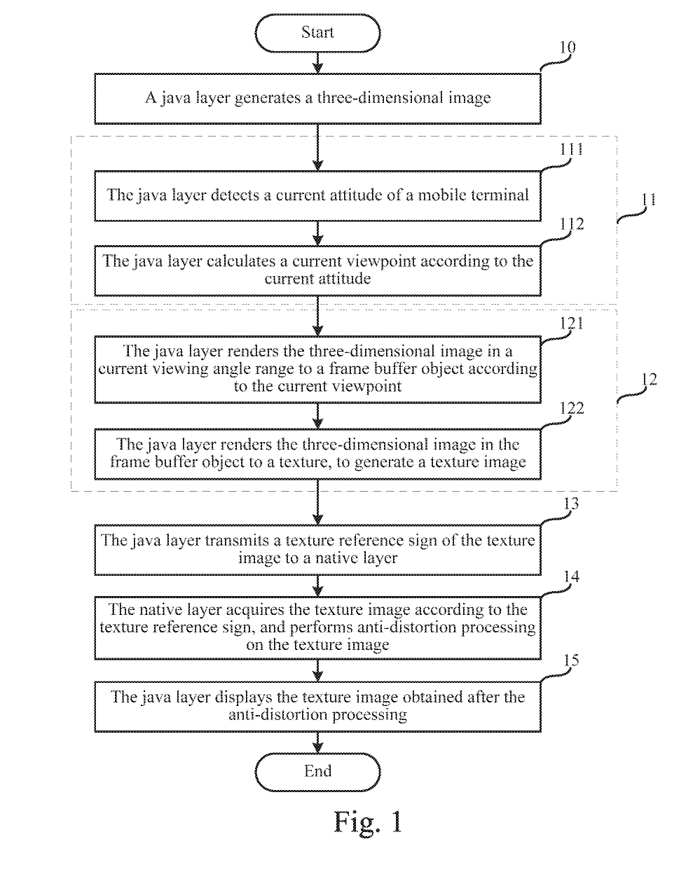

A specific process for the 360-degree image loading method in this embodiment is shown in FIG. 1.

Step 10: A java layer generates a three-dimensional image.

First, the java layer builds up a three-dimensional spherical model.

Second, the java layer acquires a two-dimensional image prestored in the internal of a mobile terminal, and adheres a texture of the two-dimensional image to the three-dimensional spherical model to generate a three-dimensional image. A specific embodiment is that: the java layer generates a texture reference sign (for example textureId), and generates, according to the texture reference sign, a surface texture (SurfaceTexture); the java layer creates an empty surface to receive the two-dimensional image by using the surface texture; and the java layer binds the surface to the three-dimensional sphere body, that is, generates the three-dimensional image.

Preferably, after the texture is adhered, modification may be made on the generated three-dimensional image with respect to aspects of light and transparency, so as to make the three-dimensional image finally displayed more real.

Step 11: The java layer acquires a current viewpoint. The step 11 includes the following substeps.

Substep 111: The java layer detects a current attitude of a mobile terminal.

Specifically, when a user uses a mobile terminal, the user may change space orientation of the mobile terminal; and the current attitude reflects the space orientation of the mobile terminal. The current attitude in this embodiment is represented by an angular velocity of the mobile terminal. The angular velocity of the mobile terminal includes three angular velocities of the mobile terminal in an X, a Y, and a Z axis. However, a specific parameter representing the current attitude is not limited in this implementation manner, as long as the specific parameter can reflect the space orientation of the mobile terminal.

Substep 112: The java layer calculates the current viewpoint according to the current attitude.

Specifically, first, three angles of Euler angles are calculated according to three angular velocities of the mobile terminal in an X, a Y, and a Z axis. The three angles respectively are: yaw, representing an angle that a viewpoint rotates around the Y-axis; pitch, representing an angle that the viewpoint rotates around the X-axis; and roll, representing an angle that the viewpoint rotates around the Z-axis. Second, three rotation matrixes matrix_yaw=matrix::rotateY(yaw); matrix_pitch=matrix::rotateX(pitch); and matrix_roll=matrix::rotateZ(roll) are calculated according to the three angles of the Euler angles. That is, the current viewpoint is actually represented by the three rotation matrixes.

It should be noted that an acquiring manner of the current viewpoint is not limited in this embodiment; and in other embodiments, the current viewpoint may also be a recommended viewpoint (representing a good viewing angle) prestored in the mobile terminal, or may be multiple continuously changing viewpoints prestored in the mobile terminal.

Step 12: The java layer renders the three-dimensional image in a current viewing angle range to a texture according to the current viewpoint, to generate a texture image. The step 12 includes the following substeps.

Substep 121: The java layer renders the three-dimensional image in the current viewing angle range to a frame buffer object according to the current viewpoint.

First, the java layer creates the frame buffer object (Frame buffer object). Second, the java layer calculates vertex coordinates of the three-dimensional image in the current viewing angle range according to the current viewpoint (that is, the three rotation matrixes), so as to render the three-dimensional image in the current viewing angle range to the frame buffer object according to the calculated vertex coordinates. An image in the frame buffer object is an image displayed on a display screen.

Substep 122: The java layer renders the three-dimensional image in the frame buffer object to the texture, to generate the texture image.

First, the java layer generates a new texture reference sign (textureId_new), and generates, according to the new texture reference sign (textureId_new), a surface texture (SurfaceTexture). Second, the java layer renders the three-dimensional image in the frame buffer object to the surface texture (SurfaceTexture), to generate the texture image.

Step 13: The java layer transmits a texture reference sign of the texture image to a native layer.

That is, the java layer transmits the texture reference sign textureId_new of the texture image to the native layer.

Step 14: The native layer acquires the texture image according to the texture reference sign, and performs anti-distortion processing on the texture image.

That is, the native layer finds an actual physical location of the texture image according to the texture reference sign (textureId_new) of the texture image, where the actual physical location is the foregoing frame buffer object; and the native layer directly performs the anti-distortion processing on the texture image in the frame buffer object, and the texture image obtained after the anti-distortion processing covers the original texture image to store in the frame buffer object. The anti-distortion processing is performed for eliminating a distortion phenomenon occurred when a subsequent user watches an image by using a lens. A person skilled in the art should know a specific manner of the anti-distortion processing, and details are not described herein again.

Step 15: The java layer displays the texture image in the frame buffer object obtained after the anti-distortion processing on a display screen.

According to the 360-degree image loading method provided in this embodiment, a first data layer (a java layer in this embodiment) implements rendering and drawing to generate a three-dimensional image; and after the first data layer renders the three-dimensional image in a current viewing angle range to a texture, the first data layer transmits a texture reference sign to a second data layer (a native layer in this embodiment), and the second data layer implements anti-distortion processing. That is, in a 360-degree video display process, only the texture reference sign needs to be transmitted between the first data layer and the second data layer, so that transmission of a large amount of video broadcast control data between the first data layer and the second data layer is avoided, improving the program development efficiency. Moreover, rendering and drawing of the three-dimensional image is complemented in the first data layer, that is, data related to the rendering and drawing needs to be used only in the first data layer but not used in the second data layer, thereby effectively avoiding sharing of data related to the rendering and drawing between the first data layer and the second data layer, and simplifying complexity of program development.

Steps of the foregoing methods are divided only for a clear description, and may be combined as one step or some steps may be divided into multiple steps during implementation, as long as the steps contains a same logical relationship, the steps all fall within the protection scope of the present disclosure; and a core design in which inconsequential modifications are added or inconsequential designs are introduced in an algorithm or a process, but the algorithm and the process are not changed all fall within the protection scope of the present disclosure.

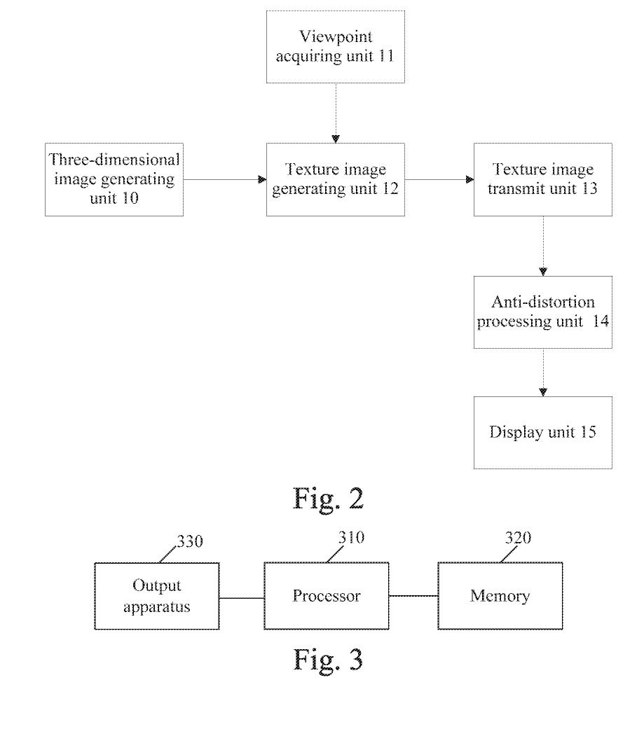

Embodiment 2 of the present disclosure relates to a 360-degree image loading module, as shown in FIG. 2, including: a three-dimensional image generating unit 10, a viewpoint acquiring unit 11, a texture image generating unit 12, a texture image transmit unit 13, an anti-distortion processing unit 14, and a display unit 15.

The three-dimensional image generating unit 10 is configured to generate a three-dimensional image.

The viewpoint acquiring unit 11 is configured to acquire a current viewpoint. Specifically, the viewpoint acquiring unit 11 further includes: an attitude detection subunit and a viewpoint calculating subunit. The attitude detection subunit is configured to detect a current attitude of a mobile terminal; and the viewpoint calculating subunit is configured to calculate the current viewpoint according to the current attitude. The attitude detection subunit includes a gyroscope.

The texture image generating unit 12 is configured to render the three-dimensional image in a current viewing angle range to a texture according to the current viewpoint, to generate a texture image.

The image transmit unit is configured to transmit a texture reference sign of the texture image to the anti-distortion processing unit 14.

The anti-distortion processing unit 14 is configured to: acquire the texture image according to the texture reference sign, and perform anti-distortion processing on the texture image.

The display unit 15 is configured to display the texture image obtained after the anti-distortion processing.

It is not difficult to find that this embodiment is a system embodiment corresponding to Embodiment 1, and this embodiment can be implemented in mutual cooperation with the first embodiment. Details of related arts described in Embodiment 1 are still in force in this embodiment. To avoid repetition, details are not described herein again. Correspondingly, the details of the related arts described in this embodiment can also be applied to Embodiment 1.

It should be noted that each of modules involved in this embodiment is a logical module. In an actual application, a logical unit may be a physical unit, or may be a part of the physical unit, or may be implemented by combinations of multiple physical units. Moreover, to emphasize the innovated part of the present disclosure, a unit not in a close relationship with the technical problems provided in the present disclosure is not introduced in this embodiment, but this does not indicate that there is no other unit in this embodiment.

Steps of the method and the algorithm described with reference to the embodiments disclosed in this application may directly be reflected in hardware, a software module executed by a processor, or a combination of the two. The software module may reside in an random access memory (RAM), a flash memory, a read only memory (ROM), a programmable read only memory, an erasable read only memory (PROM), an erasable programmable read only memory (EPROM), an electrically erasable programmable read only memory (EEPROM), a register, a hard disk, a removable disk, a compact disk read only memory (CD-ROM) or storage media of any other forms known in the art. In an alternative solution, the storage medium and the processor may be one-piece. The processor and the storage medium may reside in an application specific integrated circuit (ASIC). The ASIC may reside in a computing device or user equipment, or the processor and the storage medium may reside in a computing device or user equipment as a discrete component.

Embodiment 3 of this application provides a non-volatile computer storage medium, which stores a computer executable instruction, where the computer executable instruction can be executed to perform the 360-degree image loading method in any one of the foregoing method embodiments.

FIG. 3 is a schematic structural diagram of hardware of an electronic device for executing a 360-degree image loading method according to Embodiment 4 of this application. As shown in FIG. 3, the device includes:

one or more processors 310 and a memory 320, where only one processor 310 is used as an example in FIG. 3.

An electronic device for executing the 360-degree image loading method may further include an output apparatus 330.

The processor 310, the memory 320, and the output apparatus 330 can be connected by means of a bus or in other manners. A connection by means of a bus is used as an example in FIG. 3.

As a non-volatile computer readable storage medium, the memory 320 can be used to store non-volatile software programs, non-volatile computer executable programs and modules, for example, a program instruction/module corresponding to the 360-degree image loading method in the embodiments of this application (for example, the three-dimensional image generating unit 10, the viewpoint acquiring unit 11, the texture image generating unit 12, the texture image transmit unit 13, the anti-distortion processing unit 14, and the display unit 15 shown in FIG. 2). The processor 310 executes various functional applications and data processing of the 360-degree image loading module, that is, implements the 360-degree image loading method of the foregoing method embodiments, by running the non-volatile software programs, instructions, and modules that are stored in the memory 320.

The memory 320 may include a program storage area and a data storage area, where the program storage area may store an operating system and an application that is needed by at least one function; the data storage area may store data created according to use of the 360-degree image loading module, and the like. In addition, the memory 320 may include a high-speed random access memory, or may also include a non-volatile memory such as at least one disk storage device, flash storage device, or another non-volatile solid-state storage device. In some embodiments, the memory 320 optionally includes memories that are remotely disposed with respect to the processor 310, and the remote memories may be connected, via a network, to the 360-degree image loading module. Examples of the foregoing network include but are not limited to: the Internet, an intranet, a local area network, a mobile communications network, or a combination thereof.

The output apparatus 330 may include a display device, for example, a display screen used to display a texture image obtained after the anti-distortion processing.

The one or more modules are stored in the memory 320; when the one or more modules are executed by the one or more processors 310, the 360-degree image loading method in any one of the foregoing method embodiments is executed.

The foregoing product can execute the method provided in the embodiments of this application, and has corresponding functional modules for executing the method and beneficial effects. Refer to the method provided in the embodiments of this application for technical details that are not described in detail in this embodiment.

The electronic device in this embodiment of this application exists in multiple forms, including but not limited to:

(1) Mobile communication device: such devices are characterized by having a mobile communication function, and primarily providing voice and data communications; terminals of this type include: a smart phone (for example, an iPhone), a multimedia mobile phone, a feature phone, a low-end mobile phone, and the like;

(2) Ultra mobile personal computer device: such devices are essentially personal computers, which have computing and processing functions, and generally have the function of mobile Internet access; terminals of this type include: PDA, MID and UMPC devices, and the like, for example, an iPad;

(3) Portable entertainment device: such devices can display and play multimedia content; devices of this type include: an audio and video player (for example, an iPod), a handheld game console, an e-book, an intelligent toy and a portable vehicle-mounted navigation device;

(4) Server: a device that provides a computing service; a server includes a processor, a hard disk, a memory, a system bus, and the like; an architecture of a server is similar to a universal computer architecture. However, because a server needs to provide highly reliable services, requirements for the server are high in aspects of the processing capability, stability, reliability, security, extensibility, and manageability; and

(5) other electronic apparatuses having a data interaction function.

The apparatus embodiment described above is merely exemplary, and units described as separated components may be or may not be physically separated; components presented as units may be or may not be physical units, that is, the components may be located in a same place, or may be also distributed on multiple network units. Some or all modules therein may be selected according to an actual requirement to achieve the objective of the solution of this embodiment.

Through description of the foregoing implementation manners, a person skilled in the art can clearly learn that each implementation manner can be implemented by means of software in combination with a universal hardware platform, and certainly, can be also implemented by using hardware. Based on such understanding, the essence, or in other words, a part that makes contributions to relevant technologies, of the foregoing technical solutions can be embodied in the form of a software product. The computer software product may be stored in a computer readable storage medium, for example, a ROM/RAM, a magnetic disk, or a compact disc, including several instructions for enabling a computer device (which may be a personal computer, a sever, or a network device, and the like) to execute the method in the embodiments or in some parts of the embodiments.

Finally, it should be noted that: the foregoing embodiments are only used to describe the technical solutions of this application, rather than limit this application. Although this application is described in detail with reference to the foregoing embodiments, a person of ordinary skill in the art should understand that he/she can still modify technical solutions disclosed in the foregoing embodiments, or make equivalent replacements to some technical features therein; however, the modifications or replacements do not make the essence of corresponding technical solutions depart from the spirit and scope of the technical solutions of the embodiments of this application.

1. A 360-degree image loading method, applied to an electronic device, comprising:
generating, by a first data layer, a three-dimensional image;
acquiring, by the first data layer, a current viewpoint;
rendering, by the first data layer, the three-dimensional image in a current viewing angle range to a texture according to the current viewpoint, to generate a texture image.
transmitting, by the first data layer, a texture reference sign of the texture image to a native layer; and
acquiring, by a second data layer, the texture image according to the texture reference sign, and performing anti-distortion processing on the texture image.

2. The 360-degree image loading method according to claim 1, the rendering, by the first data layer, the three-dimensional image in a current viewing angle range to a texture according to the current viewpoint, to generate a texture image comprises:
rendering, by the first data layer, the three-dimensional image in the current viewing angle range to a frame buffer object according to the current viewpoint; and
rendering, by the first data layer, content of the frame buffer object to the texture, to generate the texture image.

3. The 360-degree image loading method according to claim 1, the step of acquiring a current viewpoint comprises:
detecting, by the first data layer, a the current attitude of a mobile terminal; and
calculating, by the first data layer, the current viewpoint according to the current attitude.

4. The 360-degree image loading method according to claim 3, wherein the current viewpoint is represented at least by an angular velocity of the mobile terminal.

5. The 360-degree image loading method according to claim 1, after the step of performing, by the second data layer, anti-distortion processing on the texture image, further comprising:
displaying, by the first data layer, the texture image obtained after the anti-distortion processing.

6. The 360-degree image loading method according to claim 1, the first data layer is a java layer, and the second data layer is a native layer.

7-12. (canceled)

13. A non-volatile computer storage medium, which stores computer executable instructions, wherein the computer executable instructions are configured to:
generate, by a first data layer, a three-dimensional image;
acquire, by the first data layer, a current viewpoint;
render, by the first data layer, the three-dimensional image in a current viewing angle range to a texture according to the current viewpoint, to generate a texture image;
transmit, by the first data layer, a texture reference sign of the texture image to a native layer; and
acquire, by a second data layer, the texture image according to the texture reference sign, and performing anti-distortion processing on the texture image.

14. An electronic device, comprising:
at least one processor; and
a memory communicably connected with the at least one processor for storing instructions executable by the at least one processor,
wherein execution of the instructions by the at least one processor causes the at least one processor to:
generate, by a first data layer, a three-dimensional image;
acquire, by the first data layer, a current viewpoint;
render, by the first data layer, the three-dimensional image in a current viewing angle range to a texture according to the current viewpoint, to generate a texture image;
transmit, by the first data layer, a texture reference sign of the texture image to a native layer; and
acquire, by a second data layer, the texture image according to the texture reference sign, and performing anti-distortion processing on the texture image.

15. The non-volatile computer storage medium according to claim 13, wherein to render, by the first data layer, the three-dimensional image in a current viewing angle range to a texture according to the current viewpoint, to generate a texture image the at least one processor is specifically caused to:
render, by the first data layer, the three-dimensional image in the current viewing angle range to a frame buffer object according to the current viewpoint; and
render, by the first data layer, content of the frame buffer object to the texture, to generate the texture image.

16. The non-volatile computer storage medium according to claim 13, wherein to acquire a current viewpoint the at least one processor is specifically caused to:
detect, by the first data layer, a the current attitude of a mobile terminal; and
calculate, by the first data layer, the current viewpoint according to the current attitude.

17. The non-volatile computer storage medium according to claim 16, wherein the current viewpoint is represented at least by an angular velocity of the mobile terminal.

18. The non-volatile computer storage medium according to claim 13, wherein after the performing, by the second data layer, anti-distortion processing on the texture image, the computer executable instructions are further configured to:
display, by the first data layer, the texture image obtained after the anti-distortion processing.

19. The non-volatile computer storage medium according to claim 13, wherein first data layer is a java layer, and the second data layer is a native layer.

20. The electronic device according to claim 14, wherein to render, by the first data layer, the three-dimensional image in a current viewing angle range to a texture according to the current viewpoint, to generate a texture image the at least one processor is specifically caused to:
render, by the first data layer, the three-dimensional image in the current viewing angle range to a frame buffer object according to the current viewpoint; and
render, by the first data layer, content of the frame buffer object to the texture, to generate the texture image.

21. The electronic device according to claim 14, wherein to acquire a current viewpoint the at least one processor is specifically caused to:
detect, by the first data layer, a the current attitude of a mobile terminal; and
calculate, by the first data layer, the current viewpoint according to the current attitude.

22. The electronic device according to claim 21, wherein the current viewpoint is represented at least by an angular velocity of the mobile terminal.

23. The electronic device according to claim 14, wherein after the performing, by the second data layer, anti-distortion processing on the texture image, the computer executable instructions are further configured to:
display, by the first data layer, the texture image obtained after the anti-distortion processing.

24. The electronic device according to claim 14, wherein the first data layer is a java layer, and the second data layer is a native layer.
